(19) United States
(12) Patent Application Publication
(10) Pub. No.: US 2017/0092225 A1
(43) Pub. Date: Mar. 30, 2017

(54) PUBLISHING TO DIGITAL SIGNAGE

(71) Applicant: Grand Visual LLC, New York, NY (US)

(72) Inventors: Neil Morris, London (GB); Daniel Dawson, London (GB)

(21) Appl. No.: 14/869,208

(22) Filed: Sep. 29, 2015

(51) Int. Cl. G09G 5/00; G06T 1/60

(52) U.S. Cl. CPC G09G 5/006; G06T 1/60

(57) ABSTRACT

Publishing of content on digital signage includes supplying a content, suitable for publication on digital signage, to a platform from a source arranged in association with the platform; trafficking the content from the platform to the digital signage by means of a feed; publishing the content on the digital signage; providing a folder at the digital signage comprising the content; generating a summary file at the platform related to a new content and forwarding the summary file to the digital signage. The summary file may be used to identify and select new and/or updated parts of new content by comparison with the content stored in the folder. Selected parts of new content are sent to the platform via the feed and only the new and/or updated parts of the new content to the digital signage are trafficked according to the selection.

### FIELD OF THE DISCLOSURE

The present disclosure relates to publishing content on digital signage.

### BACKGROUND

Digital signage has become an important tool in advertising and display. Advances in digital signage technology have enabled interaction of advertisers and other users with a large audience to provide information in a targeted, interactive, and current manner. Digital signage can be updated regularly, in a centrally controlled manner where appropriate. Content displayed may comprise real-time text, video RSS and social media feeds, published substantially instantly to e.g. a display apparatus.

### SUMMARY

According to an object of the present disclosure, there is provided a method for publishing content on a digital signage which includes supplying a content, suitable for publication on digital signage, to a platform from a source operatively coupled with the platform (100); with a feed, trafficking the content from the platform to the digital signage (110); publishing the content on the digital signage (120); providing a folder at the digital signage comprising the content (130); at the platform, generating a summary file related to a new content; and forwarding the summary file to the digital signage (140).

According to another object of the disclosure, a non-transitory computer-readable medium is provided for publishing content on a digital signage. Instructions stored on the computer-readable medium, when executed on a processor, cause one or more computers to supply a content suitable for publication on digital signage to a platform from a source operatively coupled with the platform (100); with a feed, traffic the content from the platform to the digital signage (110); publish the content on the digital signage (120); provide a folder at the digital signage comprising the content (130); at the platform, generate a summary file related to a new content; and forward the summary file to the digital signage (140).

According to yet another object of the present disclosure, there is provided a system for publishing content (230) on a digital signage comprising a source (240) arranged to supply (260) a content (230) suitable for publication on a digital signage (210); a platform (250) operatively coupled with the source (240) to receive the content therefrom, arranged to communicate with the digital signage (210) via a feed (280) suitable to feed the content (230) to the digital signage (210) and including means (270) to generate a summary file related to a new content for forwarding to the digital signage (210) via the feed (280); and a digital signage (210) including a folder (220) for holding the content (230), the digital signage configured for publishing the content (230).

It will be appreciated that features of the disclosure are susceptible to being combined in any combination without departing from the scope of the disclosure as defined by the appended claims.

### DESCRIPTION OF THE DIAGRAMS

Embodiments of the present disclosure will now be described, by way of example only, with reference to the following diagrams wherein:

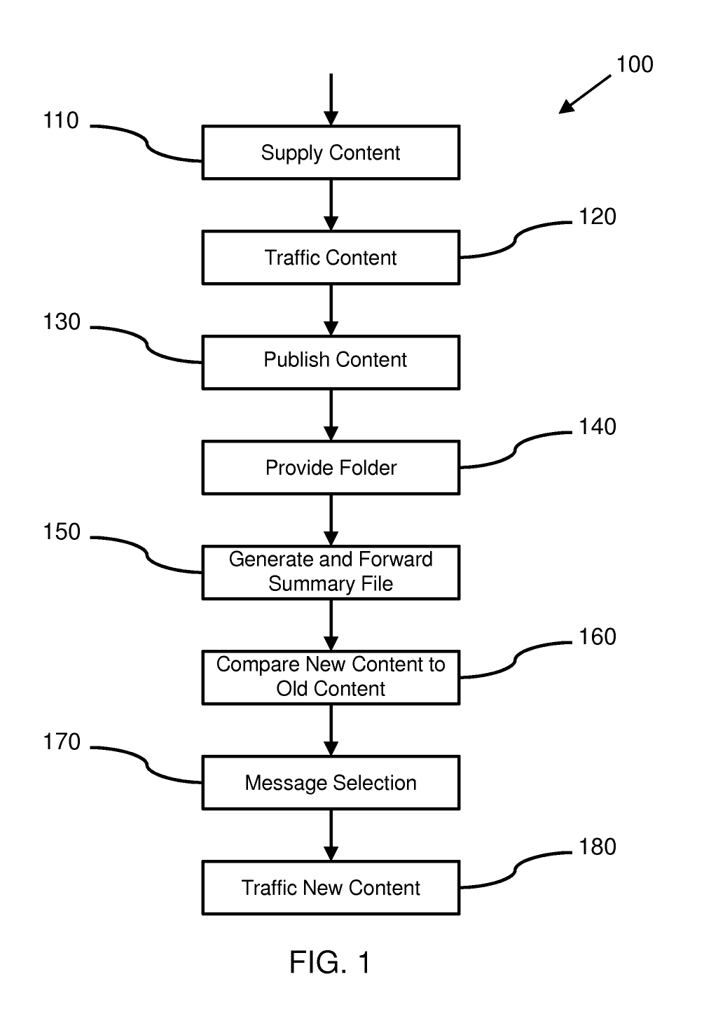

FIG. 1 is an illustration of a method according to an embodiment of the present disclosure;

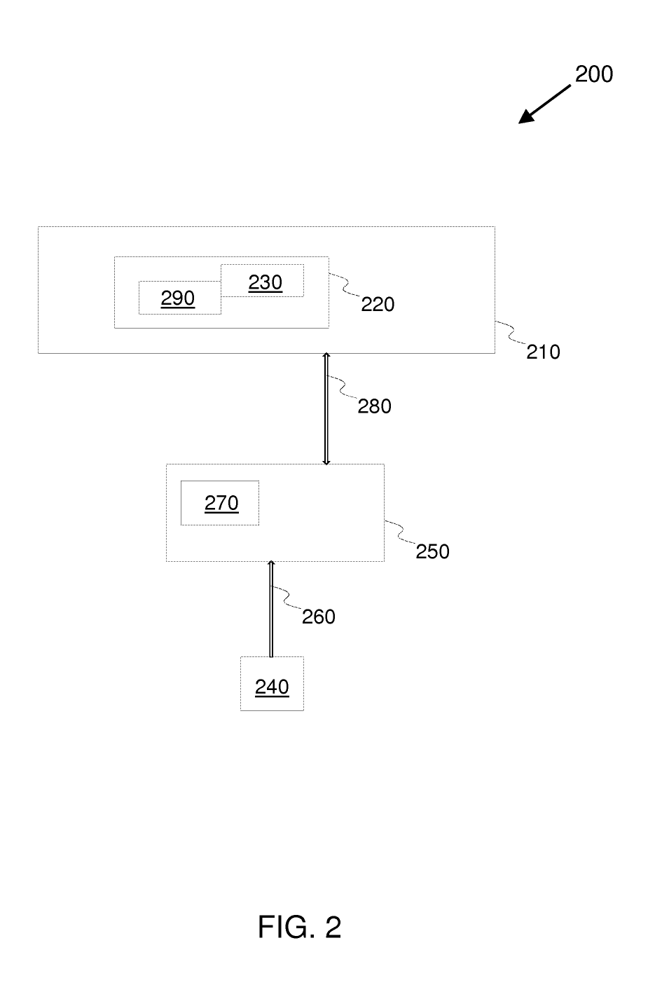

FIG. 2 is a schematic illustration of a system according to an embodiment of the present disclosure;

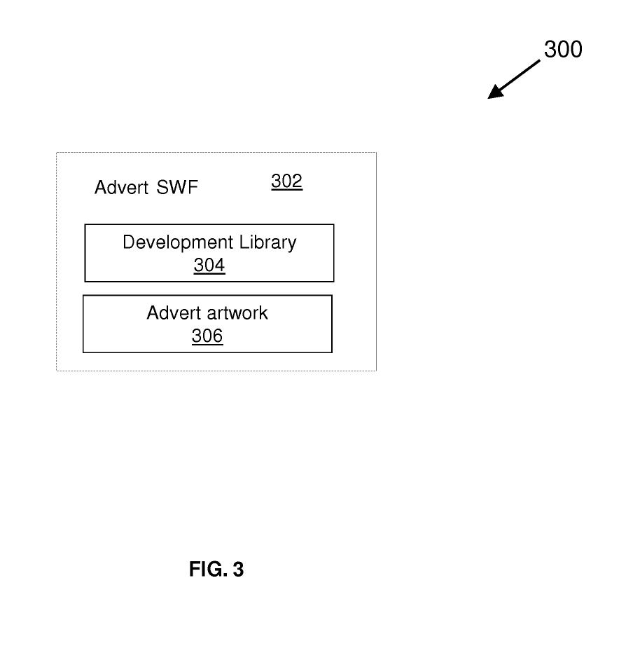

FIG. 3 is an illustration for developing an advert in an embodiment of the present disclosure;

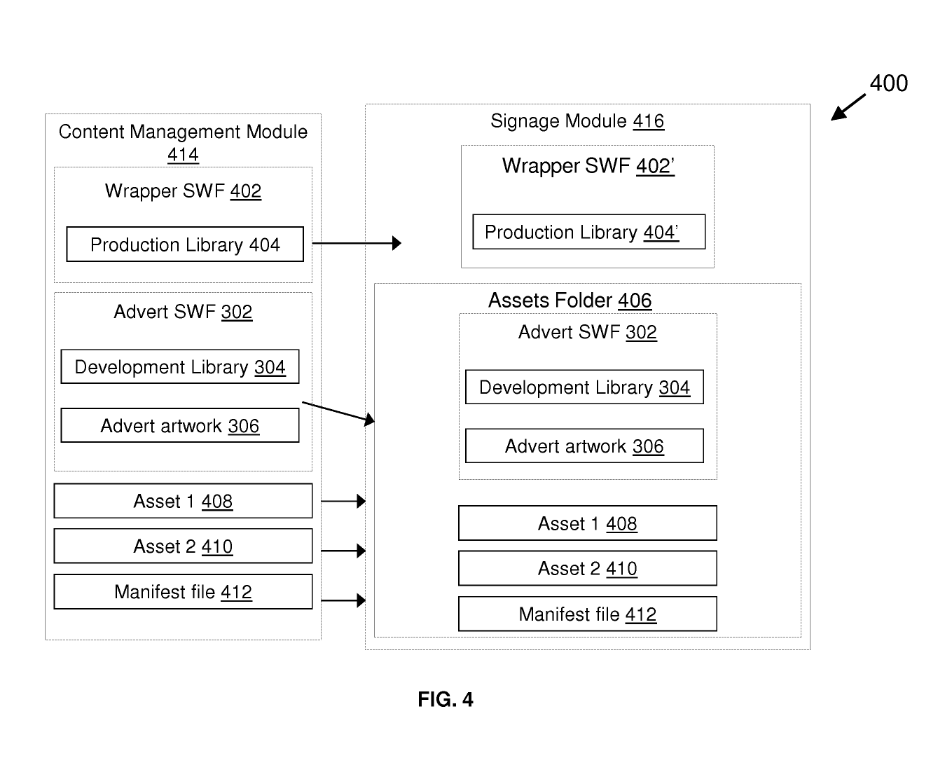

FIG. 4 is an example implementation for displaying an updated advert SWF on the digital signage in an embodiment of the present disclosure; and

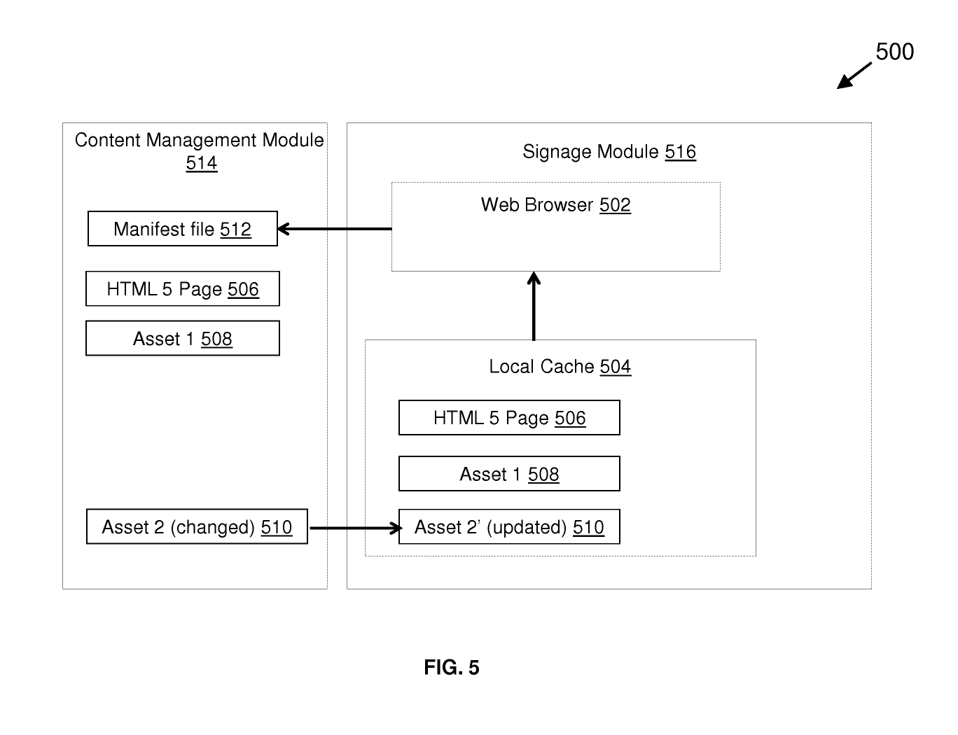

FIG. 5 is an example implementation for displaying advert via HTML 5 in an embodiment of the present disclosure.

### DETAILED DESCRIPTION

Digital signage may comprise a single device or a network of connected devices and is frequently placed in an environment outside of the home (OOH), which may comprise out of doors or outside environments, the devices and systems then being categorised as digital out of home (DOOH). There are many digital OOH networks in various countries, examples including JC Decaux™, Lamar Advertising Company™ and Clear Channel Outdoor™.

In the field of computers a platform is an underlying computer system on which application programs can run. A platform consists of an operating system, built on the instruction set for a processor or microprocessor performing logic operations and managing data movement in the computer. In accordance with the present disclosure, application programs implement a method connected with the operation or the digital signage, in terms of its actual operation or the associated content targeted to the digital signage. Known platforms are frequently integrated with digital outdoor networks and arranged suitable to operate with the varying characteristics of the differing networks.

The content to be presented on the digital signage can be derived from other media or can be created as an entity, which is then published on the digital media.

When describing various embodiments, it will be appreciated that the inventive concepts can be applied singly or in combination with the goal of enhancing the efficiency and accuracy of the publication of content on digital signage.

The present disclosure seeks to provide an efficient update of displayed content on digital signage and be capable of delivering content across the different and varied digital OOH networks.

In FIG. 1, illustrates an embodiment of the present disclosure in the form of a method.

at 110, content is supplied, suitable for publication on digital signage, to a platform from a source arranged in association with the platform. The content is trafficked from the platform to the digital signage by means of a feed at 120. Trafficking of the content facilitates publishing the content on the digital signage at 130. In this manner, the digital signage receives information to be published on the presentation area or screen of the digital signage. This information comprises images, data, dynamic video, interactive messages, advertising etc. Under the present state of the art, any updates are made available to the digital signage from a source of information by resending complete packages of the information. Refreshing of the published content is achieved by provision of a complete set of data, some of which may be identical to the already published information.

Many different embodiments of the present disclosure exist. One example embodiment is now presented in more detail and comprises the use of HTML 5 files (the content) to permit specific updating of web information.

A folder is provided to the digital signage in order to comprise the content at 140. At 150, this folder is then utilised when generating a summary file at the platform related to a new content and forwarding the summary file to the digital signage. The summary file is to identify and select new and/or updated parts of the new content by comparison with the content in the folder at 160. The provision of the folder file provides a status of the content being displayed at an instant by the digital signage which is immediately available for comparison with a summary file, generated when a new content becomes available from the source. This direct comparison makes it possible to identify which parts of the new information are the same as the currently displayed information and, at the same time, to identify which parts of the displayed information are not current and need to be updated. The selection of desired and/or necessary updates is then clear. By messaging a resulting selection to the platform via the feed at 170, it is possible to select the appropriate information relating to the selection in the new content. Then, at 180, trafficking only the new and/or updated parts of the new content to the digital signage according to the selection, results in an optimised data transfer, likely to involve less data and thereby efficiently using resources. Further, any update at the digital signage is less time consuming and results in less disruption to any displayed information.

Referring to FIG. 2, a system 200 is configured to implement a method according to embodiments of the present disclosure. Specifically, system 200 may include a digital signage 210, which may further include an out-of-home screen, for example. Digital signage 210 is used to display information in a visually attractive manner, by use of images, videos etc., such information comprising e.g. sales and advertising campaigns or useful public information, such as weather reports. Also included with digital signage 210 is a folder 220 wherein a content 230, which, relates to the information displayed by the digital signage, is stored. The origin of content 230 is a source 240, which may include but is not limited to social media applications and advertising related information. Frequently, source 240 is owned or handled by an owner different from that of digital signage 210. Since a number of source owners may be authorized to publish content to digital signage 210, various protocols, security and log-in credentials may be provided for use and access between system components.

Source 240 first supplies information content to a platform 250 by means of a connection 260. Connection 260 may be implemented as a wired or wireless network connection, for example, or it may take the form of hardware, such as a memory device. Platform 250 comprises a means 270 to generate a summary file related to any new content arriving from source 240. Platform 250 may be co-located with digital signage 210 or may be provided at a location separate and/or remote therefrom. In the latter case, communication and transfer of data and information between platform 250 and digital signage 210 is facilitated by means of a feed 280. Feed 280 allows communication in two directions and may be implemented e.g. as a wireless network or by wired connection.

The generated summary file is transferable from platform 250 to digital signage 210 by means of, for example, feed 280. A comparison of the summary file with content 230 is then affected by a comparison means 290 arranged to use the summary file to identify and select new and/or updated parts of the new content by comparison with the content in the folder. The comparison results in an identified selection of the parts of content 230 which require updating in terms of the new content supplied. This selection is returned to platform 250 where an action can be undertaken to supply full information and/or data relating only to the selected components of the new content to digital signage 210.

More generally, the various embodiments of the present disclosure may relate to a system and method of publishing dynamic campaigns on digital signage. Platform 250 can be optionally arranged for publishing, for example, custom feeds from Facebook™, Instagram™, Twitter™, custom fed XML or Image/text/video. Custom feeds can comprise condition dependent feeds. The dynamic campaigns can be stored in, for example, SWF files or HTML5 located at the digital signage onsite at a particular location. The method may include one SWF which may be referred to as a parent loading a second SWF which may be referred to as a child SWF. The child SWF may be applied dynamically by the system dependent on sigange programming and media owner who will be receiving the SWF. Names can be arranged to be the same in the library, can check if things have changed. Programming of the child SWF (dynamic asset) sitting in the parent swift can be arranged.

Embodiments of the disclosure may further include a trafficking system for outdoor digital signage. Automated review of content files can be implemented by consideration of, for example, size, duration, orientation, flash type etc. In an example, reviews are pushed out to the media owner's digital signage via linear delivery via a web interface Media Owners area into which media owners log to retrieve their files which have been both automatically and manually checked by web interface and are ready to be loaded into a signage module.

Embodiments of the present disclosure also comprise analytics for the outdoor screens. In a first example method for reporting analytics a SWF file reports back to the server what and when it is playing out. In a second example method for reporting analytics, the system ingests logs from signage software to generate a report. In a third example method for reporting analytics in a system employing HTML5, the system tracks when the URL is pulled from the platform.

A platform for out of home screens, according to embodiments of the present disclosure, allows publishing via the platform and works for a plurality of media channels which may comprise feeds from Facebook, Instagram, Twitter, custom fed XML, Image/text/video uploading and roll out. The platform can be arranged to sit on servers and use SWF files located at the screens onsite to publish contents or HTML files synchronized from the platform to the digital signage. In an example, an advertiser may have thousands of screens roadside which may be synched with the platform on the media side, thereby providing the advertiser with the content/assets to digital dynamic outdoor campaigns.

In an example, an Instagram API (application programming interface) pulls across 5 images to the SWF file, the files are synched and play on the screen. The images (or other types of files text/video/etc.) are then forwarded and stored locally in a folder at the location of the screen which is accessible by the SWF file. According to embodiments of the present disclosure, dynamic campaigns are possible wherein only those things that are updated and new are pulled in rather than content of an entire campaign. Similar functionality can also be achieved using HTML5 instead of SWF files. Publishing then functions more like playing an online advertising banner. As such potentially thousands of screens (or even a single screen) pull down only content that has been updated. Otherwise, the locally stored material is published.

In an example operation one SWF loads a second SWF which may be considered a child SWF. The child SWF checks the library for changes. A child SWF may be programmed as a dynamic asset) sitting in the parent SWF.

Media owners all have different systems. By using aspects of the present disclosure, consistency is facilitated onto the out-of-home screen (digital signage) operators. The platform, according to embodiments of the present disclosure, enables standardization for functionality on a variety of display types. The platform is arranged to facilitate the media content based on the modifications needed for different screen providers. The SWF file and content upload to the platform can be programmed, which is thereby arranged to implement the paths and adjustments needed for the different screen owners.

Custom feed in a certain campaign can be done when a certain condition is reached or takes place. In an example, a pre-established temperature may trigger publication to digital signage. Further, such custom feeds may operate according to a SaaS model. Historically, a campaign circulation of two weeks was normal. In contemporary arrangements, a client buys a “credit space campaign” with media slots for e.g. 7 days in the next 3 months when specific set conditions occur. For example, adverts for antihistamines may be arranged to be triggered and active when the pollen counts are high or over a threshold. As such, advertising is targeted at an optimum moment to reach a customer according to conditions specified by a content owner. With a platform according to embodiments of the present disclosure, a content owner could automate the full value chain all the way back to the stock levels or media content available. Even a different value of different screen locations could be set such that, for example, a higher flow rate of consumers or more attractive screens located in prime situations or places than others, can be identified.

Referring to FIG. 3, illustrated is an example illustration 300 for developing an advert in an embodiment of the present disclosure. The advert is based on a plurality of assets. In an example, the plurality of assets includes images, manifest file, videos etc. The plurality of assets are stored within a media owners environment/database. The advert SWF 302 is developed using a development library 304 and an advert artwork module 306. The advert SWF 302 retrieves or receives assets from a folder within the development library 304.

Referring to FIG. 4, illustrated is an example system 400 for displaying an updated advert SWF on the digital signage in an embodiment of the present disclosure. The system 400 comprises signage module 416 which may, for example, be programming and/or data stored on a non-volatile memory component of digital signage 210 and content management module 414 for displaying the updated advert on digital signage. Content management module 414 may, for example, be programming and/or data stored on a non-volatile memory component of digital signage 210 or at another location. Content management module 414 updates all the assets stored in a folder of the digital signage to include the updated information. The updated advert is presented to digital signage by the signage module 416.

Content management module 414 includes a wrapper SWF 402, an advert SWF 302, a plurality of assets 408 and 410 (hereinafter collectively referred to as 408) and a manifest file 412. The wrapper SWF 402 of content management module 414 further includes a production library 404. Advert SWF 302 includes development library 304 and advert artwork 306.

Signage module 416 includes wrapper SWF 402 and plurality of asset folders 406. Wrapper SWF 402′ of signage module 416 further includes a production library 404′. Asset folders 406 include advert SWF 302, development library 304, advert artwork module 306, plurality of assets 408 and 410 and manifest file 412. The signage module 416 runs advert SWF 302 via wrapper SWF 402 and production library 404. The development library 304 in the advert SWF 302 is replaced via “ApplicationDomain” with production library 404. Thereby issuing the location of the assets stored in the media owners environment/database. Signage module 416 updates the assets in digital signage to present the updated advert.

Referring to FIG. 5, illustrated is another example system 500 for displaying advert via HTML 5 according to an embodiment of the present disclosure. System 500 includes signage module 516 and a content management module 514. The signage module 516 downloads updated advert to display the advert in the digital signage.

The content management module 514 includes a manifest file 512, HTML 5 page 506, and a plurality of assets 508 and 510 (hereinafter collectively referred to as 508). Content management module 514 stores the HTML 5 advert containing the advert artwork. The content management module 514 generates a private secure URL which media owners will place into their signage module 516. In an example, the private secure URL includes signed URL and signed cookie URL.

Signage module 516 includes an integrated web browser 502 and local cache 504. Local cache 504 includes HTML 5 page 506 and assets 508. Signage module 516 displays the HTML 5 advert at a first time by downloading assets 508 including manifest file 512 from web browser 502. While loading the HTML5 page, web browser 502 reads a cache manifest file stored at a URL on a content delivery network to identify which media asset files to cache. Web browser 502 downloads those identified media asset files which may include, for example, images, video, or tweets.

Before signage module 516 displays the advert again, manifest file 512 is checked for changes. In the example illustrated, Asset 1 508 has not changed, but Asset 2 510 has. Therefore web browser 502 downloads Asset 2 510 while Asset 1 508 is read from an existing version in the local cache.

In subsequent iterations, when loading HTML 5 page 506 web browser 502 will again check for changes of the cache manifest.

If no changes are discovered, no new or updated files will be transferred over the communications network and previously cached files will be presented on the page.

If changes are detected, new or updated files will be transferred over the communications network for presentation to the page.

When an asset 508 changes, content management module 514 modifies the cache manifest as indicated in manifest file 512. In an example, web browser 501 checks manifest file 512 regularly for changes. If changes are found, any changes assets are downloaded to the signage module 516.

Embodiments of the present disclosure are susceptible to being used for various purposes, including, though not limited to, enabling users to efficiently update advert content being presented to digital signage.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1-19. (canceled)

20. A method for publishing content on a digital signage, comprising:
supplying a content, suitable for publication on digital signage, to a platform from a source operatively coupled with the platform;
with a feed, trafficking the content from the platform to the digital signage;
publishing the content on the digital signage;
providing a folder at the digital signage comprising the content;
at the platform, generating a summary file related to a new content; and
forwarding the summary file to the digital signage.

21. The method as claimed in claim 20, further comprising:
using the summary file to identify and select new and/or updated parts of the new content by comparison with the content in the folder;
messaging a resulting selection to the platform via the feed; and
trafficking only the new and/or updated parts of the new content to the digital signage according to the selection.

22. The method as claimed in claim 21, further comprising:
arranging the folder to comprise a cache manifest.

23. The method as claimed in claim 20, further comprising:
arranging the feed to comprise a wireless network; and
operating the feed either continuously or intermittently.

24. The method as claimed in claim 20, wherein the content comprises a dynamic campaign.

25. The method as claimed in claim 20, wherein the content comprises one of more of a Flash file (SWF) stored on the folder as a dynamic file a URL, and an HTML file with associated assets.

26. The method as claimed in claim 20, wherein the summary file comprises an xml file.

27. The method as claimed in claim 20, wherein the digital signage is arranged with a plurality of digital signage devices in a digital signage network.

28. The method as claimed in claim 27, wherein the supplying, trafficking, publishing, providing, generating, and forwarding are applied selectively to a defined subgroup of the plurality of digital signage devices.

29. A non-transitory computer-readable medium for publishing content on a digital signage, comprising instructions stored thereon, that when executed on a processor, cause one or more computers to:
supply a content suitable for publication on digital signage to a platform from a source operatively coupled with the platform;
with a feed, traffic the content from the platform to the digital signage;
publish the content on the digital signage;
provide a folder at the digital signage comprising the content;
at the platform, generate a summary file related to a new content; and
forward the summary file to the digital signage.

30. A system for publishing content on a digital signage comprising:
a source arranged to supply a content suitable for publication on a digital signage;
a platform operatively coupled with the source to receive the content therefrom, arranged to communicate with the digital signage via a feed suitable to feed the content to the digital signage and including means to generate a summary file related to a new content for forwarding to the digital signage via the feed; and
a digital signage including a folder for holding the content, the digital signage configured for publishing the content.

31. The system as claimed in claim 30, wherein:
the folder comprises a comparison means arranged to use the summary file to identify and select new and/or updated parts of the new content by comparison with the content in the folder;
the feed is arranged to message a resulting selection to the platform; and
the platform is arranged to traffic only the new and/or updated parts of the new content to the digital signage according to the selection.

32. The system as claimed in claim 31, wherein the folder comprises a cache manifest.

33. The system as claimed in claim 31, wherein the feed further comprises a wireless network connection arranged for continuous or intermittent operation.

34. The system as claimed in claim 31, wherein the content comprises a dynamic campaign.

35. The system as claimed in claim 31, wherein the content comprises one or more of a Flash file (SWF) stored on the folder as a dynamic file, a URL, and an HTML file with associated assets.

36. The system as claimed in claim 31, wherein the summary file is an xml file.

37. The system as claimed in claim 31, wherein the digital signage is arranged with a plurality of digital signage devices in a digital signage network.

38. The system as claimed in claim 37, wherein one or more of the plurality of digital signage devices comprise a defined subgroup.
